(19) United States
(12) Patent Application Publication
(10) Pub. No.: US 2004/0012113 A1
(43) Pub. Date: Jan. 22, 2004

(54) Method and a device for compressing and processing a material mat

(76) Inventors: Henrik Bergstrom, Sundsvall (SE); Lars-Erik Nilsson, Sundsbruk (SE); Goran Lundgren, Alno (SE)

Correspondence Address: LERNER, DAVID, LITTENBERG,, KRUMHOLZ & MENTLIK, 600 SOUTH AVENUE WEST, WESTFIELD, NJ, 07090, US

(21) Appl. No.: 10/276,874

(22) PCT Filed: May 14, 2001
(86) PCT No.: PCT/SE01/01049

(30) Foreign Application Priority Data
May 16, 2000 (SE) 0001797-0

(51) Int. Cl. B27N 3/00; B29C 43/28

(52) U.S. Cl. 264/109; 264/324; 425/363; 425/130; 425/115

(57) ABSTRACT

Methods and apparatus for compressing and processing a mat of lignocellulose material into the form of a board are disclosed. The apparatus includes a pair of compression rolls, at least one of which has a perforated shell surface, a channel within that roll for injecting a processing medium into the mat through a restricted sector of the roll, a processing medium supply for the channel including a slide shoe which is sealingly attached to one end of the roll, and the channel includes a number of channels associated with portions of the axial width of the roll so that the processing medium can be supplied through step-wise variable portions of the width of the roll.

### FIELD OF THE INVENTION

The present invention relates to the continuous manufacturing of board by the dry method, starting with material containing lignocellulose such as wood, straw, bagasse, and the like. More specifically, the present invention relates to a method and device for compressing and processing a mat when manufacturing boards of material containing lignocellulose material.

### BACKGROUND OF THE INVENTION

The manufacture of board from lignocellulose material comprises disintegration of the raw material to particles and/or fibers of a suitable size, drying to a specific moisture ratio, glueing the material before or after drying, forming the glued material into a mat and compressing and hot-pressing the mat to a complete board.

The continuous compression and pressing of the material mats into boards can be influenced positively by injection of a suitable processing medium in the form of a gas or liquid. This also improves the properties of the completed board. An example of such a processing medium is water vapor which both heats and moistens the fibers in the material, thereby facilitating the pressing process and/or accelerating the hardening process. The injection of a hardening agent or accelerating agent into already glued mats is also possible.

It is already known through Swedish Patent No. 502,810 to introduce one or more processing media, such as steam, through at least one of the compression rolls used, this then being injected into the mat. The roll used is provided with a perforated shell surface and has a channel system arranged axially inside the shell surface. The processing medium for injection into the mat is supplied through a slide shoe sealingly abutting the end wall of the roll and then through the channel system, in a restricted sector of the roll where the mat is compressed. Like other known devices, this device has the drawback that steam can only be injected over a width corresponding to the perforated width of the roll in the axial direction. Thus, if the mat is narrower than the perforated width of the roll, steam or other processing medium will be spread outside the mat. This is a considerable drawback since it leads to steam losses and also to the steam, or other processing medium, possibly becoming a danger to the environment, particularly for people in the vicinity of the device. Investment in protective arrangements around the machinery is therefore often necessary.

Another drawback with the known device is that it cannot be used for compressing mats that are wider than the width of the roll. Several different rolls with different perforated widths must therefore be used, which are exchanged depending on the width of the mat in question. This entails considerable expense for several rolls, as well as being time-consuming.

### SUMMARY OF THE INVENTION

These and other difficulties have been resolved by the invention of a method for compressing and processing a mat of lignocellulose material into the form of a board utilizing a pair of juxtaposed compression rolls, at least one of the pair of juxtaposed compression rolls including a perforated shell surface and having a predetermined axial width, the method comprising supplying a processing medium to the at least one of the pair of juxtaposed compression rolls and injecting the processing medium through a restricted sector of the at least one of the pair of juxtaposed compression rolls along a predetermined step-wise portion of the predetermined axial width of the at least one of the pair of juxtaposed compression rolls.

In accordance with the present invention, these and other difficulties have also been overcome by the invention of apparatus for compressing and processing a mat of lignocellulose material into the form of a board comprising a pair of juxtaposed compression rolls, at least one of the pair of juxtaposed compression rolls including a pair of end walls and a perforated shell surface and having a predetermined axial width, channel means disposed within the at least one of the pair of juxtaposed compression rolls for injecting a processing medium into the mat through a restricted sector of the at least one of the pair of juxtaposed compression rolls, supply means for supplying the processing medium to the channel means, the supply means including a slide shoe sealingly attached to one of the pair of end walls of the at least one of the pair of juxtaposed compression rolls, the channel means including a plurality of channels associated with predetermined portions of the predetermined axial width of the at least one of the pair of juxtaposed compression rolls, whereby the processing medium can be supplied to stepwise variable portions of the predetermined axial width of the at least one of the pair of juxtaposed compression rolls. In a preferred embodiment, the plurality of channels includes at least one main channel and at least one axial extension channel in contact with the at least one main channel, the at least one main channel directly abutting the shell surface and the at least one axial extension channel also directly abutting the perforated shell surface whereby the processing medium can be injected through either or both of the at least one main channel and the at least one axial extension channel for application to predetermined axial portions of the predetermined axial width. In accordance with a preferred embodiment of the apparatus of the present invention, the apparatus includes a plurality of the additional axial extension channels, and each of the plurality of additional axial extension channels is directly adjacent to the perforated shell surface and progressively adjacent to the at least one axial extension channel, whereby the processing medium can be injected through additional progressive portions of the predetermined axial width of the at least one of the pair of juxtaposed compression rolls.

In accordance with one embodiment of the apparatus of the present invention, the plurality of additional axial extension channels are arranged within a predetermined limited area disposed at one of the end walls of the at least one of the pair of juxtaposed compression rolls. In a preferred embodiment, the plurality of axial extension channels are disposed at both of the end walls of the at least one of the pair of juxtaposed compression rolls, and wherein the supply means comprises slide shoe sealing members attached to both of the end walls of the at least one of the pair of juxtaposed compression rolls.

In accordance with another embodiment of the apparatus of the present invention, the slide shoe includes a main supply channel for supplying the processing medium to the at least one main channel and an axial supply channel for supplying the processing medium to the at least one axial supply channel.

In accordance with another embodiment of the apparatus of the present invention, the apparatus includes valve means for controlling the supply of the processing medium to the at least one main channel and the at least one axial extension channel.

The present invention solves the above problems by providing a method in which the injection of a processing medium can be effected over a stepwise variable axial width of the roll and by means of a device in which the channel system in the roll, arranged for the injection, comprises several channel portions in the axial direction which may be optionally supplied or not supplied with processing medium for injection over a stepwise variable axial width of the roll.

Thus, through the method and the device in accordance with the present invention, the advantage gained is that the injection width of the roll can be varied stepwise so that it can be adjusted to material mats of different widths. This offers an efficient process without unnecessary losses as regards the processing medium. Furthermore, the need for safety equipment around the device is also limited. It is also advantageous from the environmental standpoint that the processing medium is not spread unnecessarily outside the device itself. Savings are thus obtained both as regards processing medium and with respect to the device itself, not the least as regards the need for several rolls with different widths for mats of different widths, the latter to a great extent being eliminated.

In accordance with a first embodiment of the present invention, the channel system comprises channel parts in the form of a plurality of axial main channels and a plurality of axial extension channels, each of which is arranged in contact with a main channel, primarily in extension of a part of the main channel directly abutting the perforated shell surface, whereby the extension channel also abuts the shell surface so that injection of the processing medium may be performed optionally by means of either the main channel or the extension channel, or both.

In accordance with a second embodiment of the present invention, the device is provided with additional extension channels, arranged adjacent to the first-mentioned extension channels, so that several levels of extension channels are formed, each level offering an opportunity for increasing the injecting width of the roll.

### BRIEF DESCRIPTION OF THE DRAWINGS

The present invention will now be described in more detail with reference to the following detailed description which, in turn, refers to the drawings illustrating embodiments of the present invention, in which:

FIG. 1 is a side, elevational, partially schematic view of a device in accordance with the prior art;

FIG. 2 is a side, elevational, partially schematic view of a device in accordance with the present invention;

FIG. 3 is a side, elevational, partially schematic view of another device in accordance with the present invention;

FIG. 4 is a side, elevational, partially schematic view of yet another device in accordance with the present invention;

FIG. 5 is a side, elevational, partially schematic view of yet another device in accordance with the present invention;

FIG. 6 is a side, elevational, partially sectional view of an enlarged section of a device in accordance with one embodiment of the present invention; and

FIG. 7 is a side, partial, elevational, enlarged partially sectional view of a device in accordance with another embodiment of the present invention.

### DETAILED DESCRIPTION

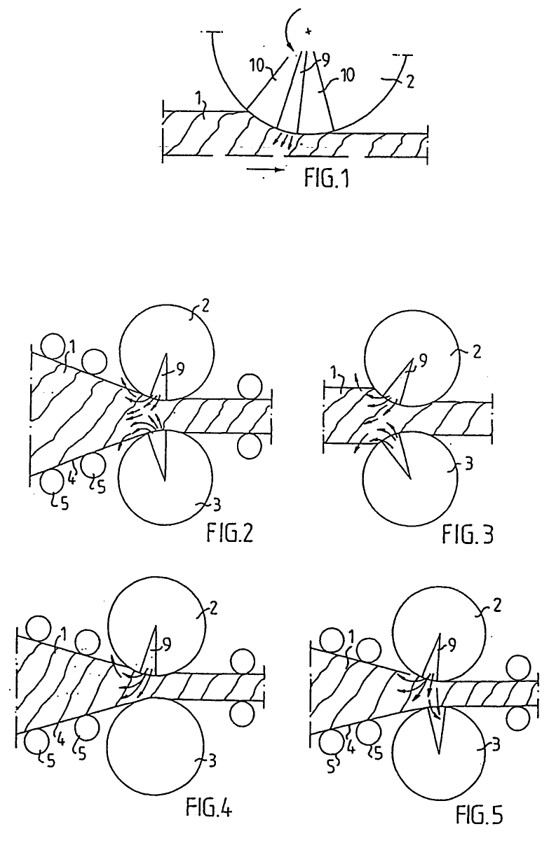

Referring to the Figures, in which like reference numerals refer to like elements thereof, when compressing and processing a material mat 1 during the manufacture of boards, the compression is performed using a compression roll 2 (FIG. 1). This roll may suitably operate as one of a pair of rolls, with a counter-roll 3, in which case compression occurs symmetrically from both sides of the mat 1. Processing medium can then be injected symmetrically through the rolls, 2 and 3, from both sides (FIGS. 2-3). This results in uniform processing of the mat and optimum removal of air from the mat during its entry. Alternatively, one roll 2 can be designed for injection, whereas the counter-roll 3 consists only of a support roll (FIG. 4) or a suction roll (FIG. 5). According to FIGS. 2, 4 and 5 wires 4 are used with rolls 5 to support the mat 1, whereas FIG. 3 shows an embodiment without a wire.

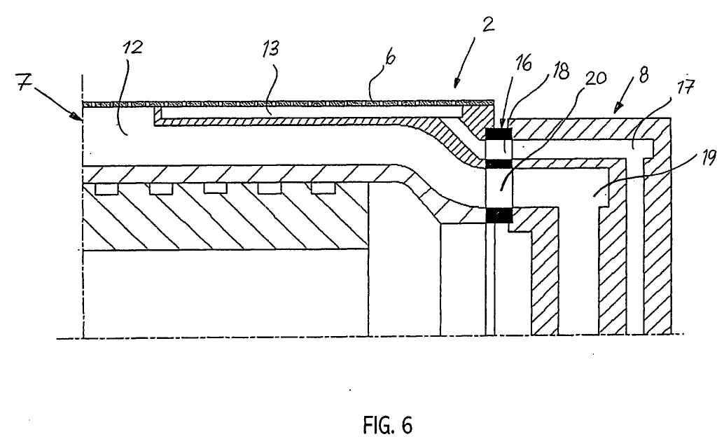

The compression and injection roll 2 shown in FIG. 6 is provided with a perforated shell surface 6 for injecting processing medium to the mat 1. A channel system 7 is arranged axially around the roll 2, inside the shell surface 6, for the supply and injection of processing medium across the width of the roll 2 and thus of the mat 1. The channel system 7 is defined, for instance, by a plurality of axial support strips carrying a perforated metal sheet that constitutes the shell surface 6 of the roll, so that a number of axial channels are formed. The device also comprises means for the supply of processing medium to the channel system 7 in the form of a slide shoe 8, which is preferably adjustable, and which sealingly abuts the end wall of the roll 2. Processing medium is supplied through this slide shoe to the channel system 7 within a restricted sector 9 of the roll 2 where the mat 1 is compressed, see FIG. 1. This restricted sector 9 is surrounded on both sides, seen peripherally, by sealing zones 10 where the roll 2 is in contact with the mat 1.

In the embodiment illustrated by way of example in FIG. 6 the channel system 7 comprises channel parts in the form of a plurality of main channels 12 and a plurality of axial extension channels 13. FIG. 6 shows one main channel (partially) and one extension channel in section. The extension channel 13 is arranged as an extension of a portion of the main channel 12 that directly abuts the perforated shell surface 6. The extension channel 13 thus also directly abuts the perforated shell surface, and injection of processing medium can therefore be effected either through only one of the channels, 12 and 13, in most cases only through the main channel 12, or through both channels, 12 and 13, thereby providing a stepwise variable injection width. Since the main channel 12 usually extends out to the end wall of the roll, more or less parallel with the shell surface, the extension channel 13 is thus outside the main channel, between the shell surface 6 and the main channel 12 where it is not in direct communication with the shell surface.

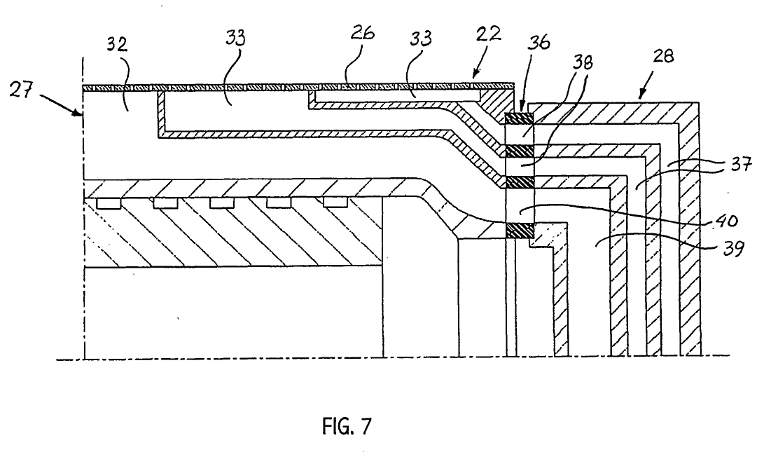

In accordance with the present invention it is perfectly feasible to arrange several extension channels, one after the other in the axial direction, in order to obtain greater variation as regards injection width. Such an embodiment of the present invention is illustrated in FIG. 7. We see here a roll 22 with a perforated shell surface 26 and a channel system 27. The figure shows a main channel 32, in section, which is extended by two extension channels 33 in the axial direction. Both of these directly abut the perforated shell surface. The roll may be provided with extension channels 33 at only one end wall, or at both end walls. For a roll some four meters long, for instance, it may be suitable with extension channels covering about one tenth of the length of the roll, at each end wall. However, the variations are infinite. It should also be emphasised that it is perfectly feasible to have more than two levels of extension channels, i.e. each main channel may be extended by more than two extension channels in the axial direction.

As to the other design details of the shell surface and channels, they may be designed as known per se through Swedish Patent No. 502,810, for example.

As already mentioned, in both embodiments a slide shoe 8, 28 is arranged outside the end wall of the roll for the supply of processing medium. This slide shoe 8, 28 is held pressed against the end wall of the roll 2, 22 by means of springs, pneumatically or hydraulically, for example. A replaceable wear part 16, 36 may advantageously be arranged between the slide shoe 8, 28 and the end wall of the roll. This wear part is usually of a material having low friction and is in contact with a machined surface of the end wall of the roll. The slide shoe 8, 28 usually covers a number of main channels 12, 32 and extension channels 13, 33 corresponding to the injection sector 9, and other channels in the roll can be sealed as the roll rotates by an adjustable slide ring of low-friction material being pressed against the end wall. The slide shoe 8, 28, as well as the wear part 16, 36, is preferably provided with a supply channel 19, 39; 20, 40, respectively, for the main channels which the slide shoe is intended to supply, and a supply channel 17, 37; 18, 38, respectively, for the corresponding extension channels. These supply channels are normally provided with valve means (not shown) for controlling the supply of processing medium so that the supply can be closed or opened as desired. If the slide shoe does not have different supply channels for the main and extension channels, respectively, some type of valve means must be provided in direct connection with the main and extension channels, respectively.

The device may be provided with a slide shoe 8, 28 at each end wall or a slide shoe only at one end wall, the second end wall then being provided with some type of sealing arrangement for the channels.

The slide shoe 8, 28 may also comprise several channels for injecting one or more processing mediums. It may also comprise channels for blow cleaning and suction. The slide shoe is preferably displaceable in the peripheral direction of the roll to enable adjustment of the position of the injection sector 9. Otherwise the slide shoe and wear part may be of conventional design, e.g. as described in Swedish Patent No. 502,810.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method for compressing and processing a material mat (1) when manufacturing boards of material containing lignocellulose with the aid of a device comprising rotatable compression rolls (2; 22), at least one of which is provided with a perforated shell surface (6; 26) and a channel system (7: 27) arranged axially inside the shell surface, the processing medium being supplied to the mat via a slide shoe (8; 28) sealingly abutting the end wall of the roll (2; 22), further via the channel system (7; 27) and the perforated shell surface, and injection of the processing medium to the mat via the perforated shell surface occurring in a restricted sector (9) of the roll (2; 22) where the mat is compressed, characterized in that the injection of the processing medium can take place over a stepwise variable axial width of the roll (2; 22).

2. A device for compressing and processing a material mat (1) when manufacturing boards of material containing lignocellulose, comprising rotatable compressing rolls (2; 22), at least one of which is provided with a perforated shell surface (6; 26) and a channel system (7: 27) arranged axially inside the shell surface for injecting processing medium to the mat, also comprising means for the supply of processing medium to the channel system (7; 27) and the perforated shell surface, said means comprising a slide shoe (8; 28) sealingly abutting the end wall of the roll (2; 22), designed so that injection of the processing medium to the mat via the channel system (7; 27) and the perforated shell surface (6; 26) occurs in a restricted sector (9) of the roll (2; 22) where the mat is compressed, characterized in that the channel system (7; 27) comprises several channel parts (12, 13; 32, 33) in axial direction which may be optionally supplied or not supplied with processing medium for injection over a stepwise variable axial width of the roll (2; 22).

3. A device as claimed in claim 2, characterized in that the channel system (7; 27) comprises channel parts in the form of a plurality of axial main channels (12; 32) and a plurality of axial extension channels (13; 33), each of which is arranged in contact with a main channel, primarily in extension of a part of said main channel directly abutting the perforated shell surface (6; 26), whereby the extension channel also abuts the shell surface so that injection of the processing medium may be performed optionally either via the main channel (12; 32) or the extension channel (13; 33) or via both.

4. A device as claimed in claim 3, characterized in that additional extension channels (33) are arranged adjacent to the first-mentioned extension channels (33), primarily in the extension of a part of the first-mentioned extension channels directly adjacent to the perforated shell surface (26), whereby the additional extension channels are also adjacent to the shell surface, thereby forming several levels of extension channels, each level offering opportunity for increasing the injecting width of the roll.

5. A device as claimed in any one of claims 34, characterized in that the extension channels (13; 33) are arranged within a limited area in conjunction with at least one end wall of the roll (2; 22).

6. A device as claimed in claim 5, characterized in that extension channels (13; 33) are arranged at both end walls of the roll (2; 22) and in that it comprises a slide shoe (8; 28) at each end wall.

7. A device as claimed in any one of claims 2-6, characterized in that the slide shoe (8; 28) is provided with a supply channel (19; 39) for the main channels (12; 32) and a supply channel (17; 37) for the extension channels (13; 33) present within said sector (9) of the roll (2; 22).

8. A device as claimed in any one of claims 2-7, characterized in that it comprises valve means for controlling the supply of processing medium to the various channel parts (12, 13; 32, 33) in the channel system (7; 27).
